(19) United States
(12) Patent Application Publication
(10) Pub. No.: US 2020/0213715 A1
(43) Pub. Date: Jul. 2, 2020

(54) SPEAKER

(71) Applicant: AAC Technologies Pte. Ltd., Singapore city (SG)

(72) Inventors: Chengming Cao, Shenzhen (CN); Bo Xiao, Shenzhen (CN)

(21) Appl. No.: 16/702,603

(22) Filed: Dec. 4, 2019

(30) Foreign Application Priority Data
Dec. 27, 2018 (CN) 201822226598.2

(51) Int. Cl. H04R 1/28; H04R 9/02; H04R 31/00; H04R 9/06

(52) U.S. Cl. CPC H04R 1/288; H04R 9/025; H04R 2400/11; H04R 9/06; H04R 31/006

(57) ABSTRACT

A speaker is provided. The speaker includes a holder defined by sidewalls, a vibration unit fixed to the holder, a magnetic circuit system fixed to the holder, at least one leak hole each penetrating through one of the sidewalls, at least one metal sheet each joined to one of the sidewalls through injection-molding, and at least one damping layer. The at least one metal sheet is provided with at least one through hole in a one-to one correspondence with the at least one leakage hole. The at least one damping layer is fixed to one of the at least one metal sheet by laser spot welding and completely covers the at least one through hole and the at least one leak hole.

### TECHNICAL FIELD

The present disclosure relates to the field of electro-acoustic transducing, and in particular, to a speaker.

### BACKGROUND

With the advent of the mobile Internet era, the number of smart mobile devices continues to increase. Among the numerous mobile devices, mobile phones are undoubtedly the most common and portable mobile terminal devices. Functions of the mobile phones are extremely diverse, one of which is high-quality music. Therefore, speakers for playing sound are widely used in smart mobile devices.

The speaker in the related art includes a holder defined by sidewalls, a vibration unit and a magnetic circuit system that are fixed to the holder. The sidewall is provided with a leak hole penetrating therethrough. The speaker further includes a damping layer that is fixed to the sidewall by affixing with a backing adhesive and completely covers the leak hole.

A disadvantage of the speaker in the related art lies in that in order to ensure that the damping layer is firmly affixed to the sidewall, it is necessary to ensure that a width of the backing adhesive is large enough, which results in that a size of a damping hole is limited, and it is easy for a damping to be layered and crimped.

Therefore, it is necessary to provide a new speaker to solve the above technical problems.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a perspective schematic diagram of a speaker;

FIG. 2 is an exploded diagram of a partial of a speaker; and

FIG. 3 is a cross-sectional diagram taken along line A-A of FIG. 1.

### DESCRIPTION OF EMBODIMENTS

The present disclosure will be further illustrated with reference to the accompanying drawings and the embodiments.

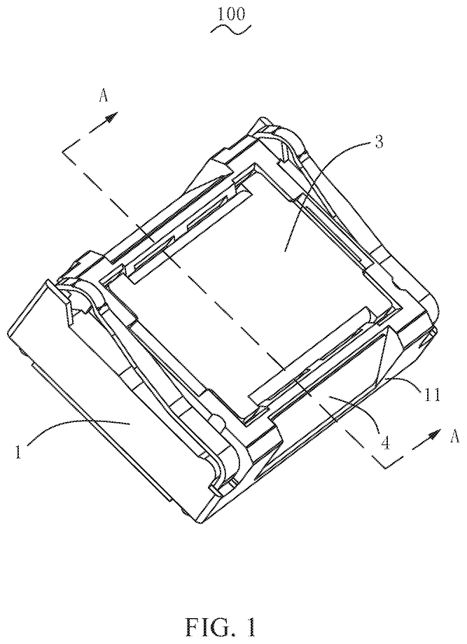

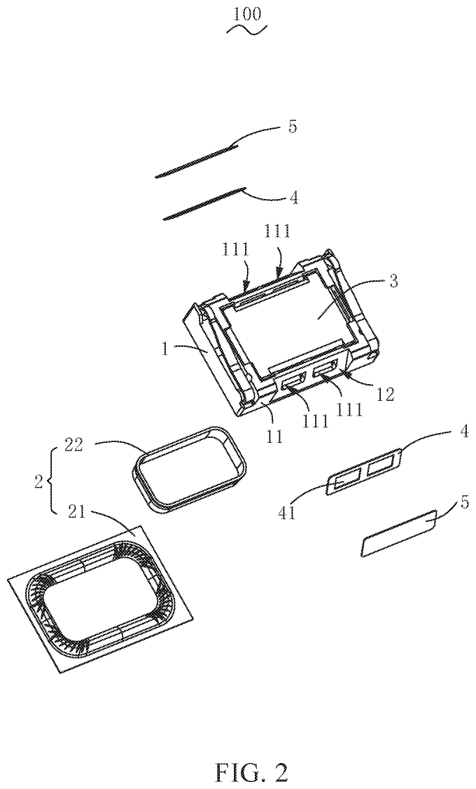

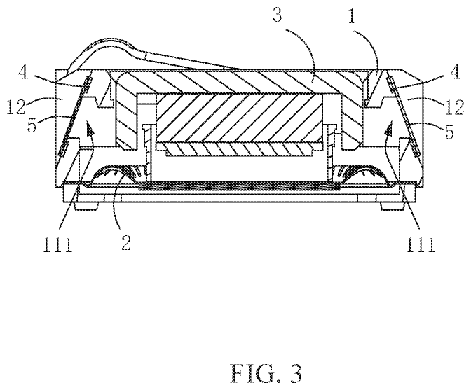

Referring to FIGS. 1-3, the present disclosure provides a speaker 100, and the speaker 100 includes a holder 1, a vibration unit 2 and a magnetic circuit system 3 that are fixed to the holder 1, a metal sheet 4 and a damping layer 5.

The vibration unit 2 is fixed to the holder 1. Optionally, the vibration unit 2 includes a diaphragm 21 fixed to the holder 1 and a voice coil 22 that drives the diaphragm 21 to vibrate.

The magnetic circuit system 3 is fixed to the holder 1. After the voice coil 22 is energized, it generates a magnetic field when cooperating with the magnetic circuit system 3, thereby driving the diaphragm 21 to vibrate and sound.

The holder 1 is defined by sidewalls 11, and a shape of the holder is not limited, which can be circular or rectangular or the like. In the present embodiment, a case where the holder 1 is in a rectangular shape defined by four sidewalls 11 is taken as an example for description.

In the present embodiment, the sidewall 11 includes a leak hole 111 penetrating therethrough, and optionally, the number of the leak hole 111 is four. The four leak holes 111 are evenly divided into two groups which are respectively disposed on two opposite sidewalls 11 of the holder 1, and the two opposite sidewalls 11 are parallel to a long axis. This facilitates design and assembly of a product. It is also feasible that two leak holes 111 can also be respectively disposed on two adjacent sidewalls 11 of the holder 1, and a principle of such configuration is the same as above. Two leak holes 111 in a one of the two groups are spaced apart from each other. Such design facilitates smooth pressure relief and ensures an acoustic performance.

The metal sheet 4 is joined to the sidewall 11 through injection-molding. The metal sheet 4 is provided with a through hole 41 corresponding to the leak hole 111. Optionally, the metal sheet 4 is a steel sheet.

The damping layer 5 is fixed to the metal sheet 4 by laser spot welding and completely covers the through hole 41 and the leak hole 111.

The speaker 100 further includes a receiving groove 12 formed by recessing of an outer side of the sidewall 11. The leak hole 111 is in communication with the receiving groove 12. The damping layer 5 is received in the receiving groove 12.

Compared with speakers in the related art, the speaker provided by the present disclosure joins the metal sheet with the sidewall through injection-molding, the metal sheet is provided with the through hole corresponding to the leak hole, and the damping layer is fixed to the metal sheet by laser spot welding and completely covers the through hole and the leak hole. In this way, a width of a fixed and joint edge of the damping layer can be greatly reduced, and the leak hole can be opened larger. Meanwhile, layering and crimping of the damping layer can be reduced.

What has been described above is only an embodiment of the present disclosure, and it should be noted herein that one ordinary person skilled in the art can make improvements without departing from the inventive concept of the present disclosure, but these are all within the scope of the present disclosure.

What is claimed is:

1. A speaker, comprising:
a holder defined by sidewalls;
a vibration unit fixed to the holder;
a magnetic circuit unit fixed to the holder;
at least one leak hole each penetrating through one of the sidewalls;
at least one metal sheet each joined to one of the sidewalls through injection-molding, the at least one metal sheet being provided with at least one through hole in a one-to-one correspondence with the at least one leakage hole; and
at least one damping layer fixed to one of the at least one metal sheet by laser spot welding and completely covering the at least one through hole and the at least one leak hole.

2. The speaker as described in claim 1, wherein each of the at least one metal sheet is a steel sheet.

3. The speaker as described in claim 1, further comprising:
a receiving groove formed by recessing of an outer side of one of the sidewalls, one of the at least one damping layer being received in the receiving groove.

4. The speaker as described in claim 1, wherein the holder has a rectangular structure; the at least one leak hole comprises four leak holes; and the four leak holes are evenly divided into two groups which are respectively disposed on two opposite sidewalls of the holder, wherein the two opposite sidewalls each are parallel with a long axis.

5. The speaker as described in claim 4, wherein two leak holes of the four leak holes in one of the two groups are spaced apart from each other.
